(19) United States
(12) Patent Application Publication
(10) Pub. No.: US 2007/0138194 A1
(43) Pub. Date: Jun. 21, 2007

(54) Pasta plate

(76) Inventor: Gianluca Castoldi, Miami, FL (US)

Correspondence Address: Robert J. Van Der Wall;Gables One Tower, Suite 1275, 1320 South Dixie Highway, Coral Gables, FL, 33146, US

(21) Appl. No.: 11/304,453

(22) Filed: Dec. 16, 2005

(51) Int. Cl. A23B 7/148

(52) U.S. Cl. 220/912; 426/106

(57) ABSTRACT

Disclosed a pasta plate having a raised border that is slightly higher than a conventional dinner plate to contain the pasta on the plate base within the perimeter in an enclosure formed by the plate side wall inside of the raised border. In a preferred embodiment of the present invention, the raised border is substantially widened in one area to provide a border for a separate high walled recess for twirling the pasta with a fork. The recess preferably has high internal walls that approximate the shape of an egg cup, but with a substantially flattened bottom that is adapted to accommodate the width of the tines of a fork which is intended to be twirled therein. Two other important features include the fact that the recess has high walls and is separated from the plate base, both of which serve to automatically limit the size of the portion being wound to that of a reasonable mouthful of pasta. Another feature is the area separating the high walled recess from pasta enclosure forms a surface which can be used with a utensil such as the fork to shorten pasta that is too long for the volume in the high walled recess, which keeps the portion in the recess to a reasonable mouthful of pasta.

### BACKGROUND OF THE INVENTION

1. Field of the Invention

The present invention relates to the field of dining accessories. More specifically, it concerns a shaped and contoured dinner plate that is especially designed for assisting a diner in eating pasta having narrow and elongated noodles. In particular, it relates to a plate having a rounded high walled recess separated from the plate base pasta enclosure which allows a diner to wind pasta around a twirled fork without the use of a separate spoon for doing so.

2. Description of the Prior Art

Eating pasta of the elongated noodle variety has historically been accomplished either by cutting the noodles to a size short enough to manage on a fork, or by twirling the pasta on a fork so that the length of the noodles can be accommodated on a fork without falling off. Many people consider the technique of cutting the pasta to fit a fork to be a childish approach to eating pasta, and thus many adult pasta diners prefer to eat using the twirled fork technique. This is usually done using a large spoon in addition to the fork wherein a mouthful of pasta is picked up by the fork, the interior of a large spoon is then placed touching or in close proximity to the ends of the tines of the fork and the fork is twirled thereon in a technique that requires a bit of practice and skill. The present invention eliminates the need for the use of the spoon because the inventive pasta plate includes a recess that substitutes for the spoon and still avoids cutting of the noodles to size.

A pre-examination search reveals the following references. McCallister et al., U.S. Design Pat. No. D477,187, Di Amico, U.S. Pat. No. 6,594,908, Edelman, U.S. Design Pat. No. D479,102, Germano, U.S. Pat. No. 6,732,636, Stewart et al., U.S. Design Pat. No. D496,565, and Asphar, U.S. Design Pat. No. Des. 396,778. Asphar is the most relevant, since it arguably includes a recess that could serve the same purpose as the present invention, but it lacks the both the high walled recess feature and separated location thereof in the present invention that are essential to its proper operation.

### SUMMARY OF THE INVENTION

Bearing in mind the foregoing, it is a principal object of present invention to provide a pasta plate to facilitate the eating of pasta.

It is another principal objective of the present invention to eliminate the necessity to either cut the pasta or to use a spoon for twirling it.

A further object of the present invention is the automatic size limiting of the amount of pasta to constitute one mouthful achieved by the separated high walled recess.

Another object of the present invention is to provide a surface area between a pasta enclosure portion of the invention and the separate high walled recess to shorten pasta that is too long for the size limitation of the recess.

An additional object of the invention is to provide a pasta plate which will make it possible for children to eat pasta without cutting the pasta or without having to master the technique with a spoon.

A further object of the invention is to facilitate the eating of pasta by people who are inexperienced with it.

An additional object of the invention is to provide a marketing advantage to restaurants who have available the pasta plate of the present invention.

Other objects and advantages will be apparent to those skilled in the art upon reference to the following descriptions and the appended drawings.

In accordance with the primary aspect of the present invention, there is disclosed a pasta plate having a raised border that is slightly higher than a conventional dinner plate to contain the pasta on the plate base within the perimeter formed by the plate side wall inside of the raised border. In a preferred embodiment of the present invention, the raised border is substantially widened in one area to provide a border for a separate high walled recess for twirling the pasta with a fork. The separation area also serves to provide a surface between a pasta enclosure portion of the invention and the separate high walled recess to shorten pasta that is too long for the size limitation of the recess.

If the foot print of the pasta plate is a curvilinear square or rectangle, the separate high walled recess would preferably be placed in one of the corners thereof, as is the preferred embodiment of the invention as shown in the appended drawings. However, it should be understood that the foot print of the plate can be any shape and the recess can be placed any where within the outer edge of the raised border including specifically in the center of the plate with no contact with the raised border. The recess preferably has high internal walls that approximate the shape of an egg cup, but with a substantially flattened bottom that is adapted to accommodate the width of the tines of a fork which is intended to be twirled therein. Several other important features include the facts that the recess has high walls and is separated from the plate base, both of which serve to automatically limit the size of the portion being wound to that of a reasonable mouthful of pasta. Alternatively, the separation provides a convenient surface to use the side of the fork or another utensil to shorten pasta that is too long.

The invention will be better understood by reference to the drawings in which:

### BRIEF DESCRIPTION OF THE DRAWINGS

FIG. 1 is a top perspective view of the inventive pasta plate.

FIG. 2 is a is an enlarged fragmentary close up perspective view of the separate high walled recess.

FIG. 3 is a bottom perspective view of the inventive pasta plate.

FIG. 4 is a cross-sectional view of the pasta plate taken along the line 4-4 of FIG. 1.

### DETAILED DESCRIPTION OF THE PREFERRED EMBODIMENT

As required, detailed embodiments of the present invention are disclosed herein: however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually appropriately detailed structure.

References now made to the drawings, where like characteristics and features of the present invention shown in the various figures are designated by the same reference numerals.

The pasta plate 10 has a substantially horizontal raised border 12 that is slightly higher than a conventional dinner plate to contain the pasta on the plate base 14 within the perimeter 16 formed by the plate side wall 18. In a preferred embodiment of the present invention, the raised border 12 is substantially widened in one area 20 to provide a border for a separate high walled recess 22 for twirling the pasta with a fork. The separation area also serves to provide a surface between a pasta enclosure portion of the invention and the separate high walled recess to shorten pasta that is too long for the size limitation of the recess.

If the foot print of the pasta plate is a curvilinear square or rectangle, the separate high walled recess 22 is preferably be placed in one of the corners 24 thereof, as in the preferred embodiment of the invention as shown in the appended drawings. However, it should be understood that the foot print of the plate can be any shape and the recess can be placed anywhere within the outer edge of the raised border including specifically in the center of the plate 10 with no contact with the raised border 12. The recess preferably has high internal walls 26 that approximate the shape of an egg cup, but with a substantially flattened circular bottom 28 that is adapted to accommodate the width of the tines of a fork which is intended to be twirled therein. Two other important features include the fact that the recess has high walls 26 and is separated at area 20 from the plate base, both of which serve to automatically limit the size of the portion being wound to that of a reasonable mouthful of pasta. Additionally, the separation area 20 provides a convenient surface to use the side of the fork or another utensil to shorten pasta that is too long.

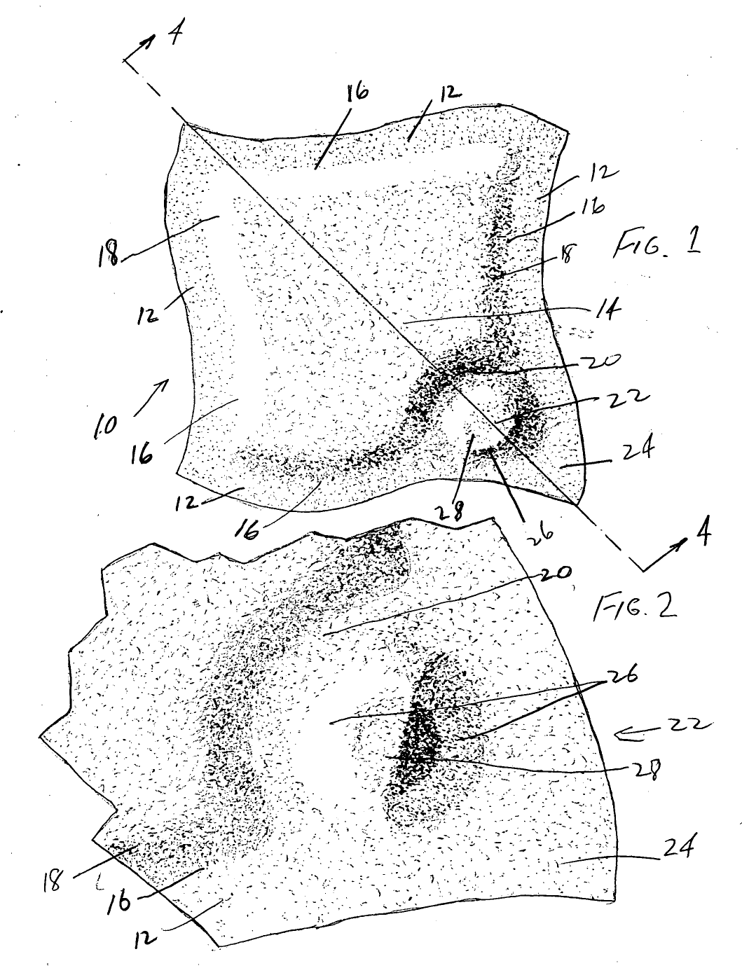

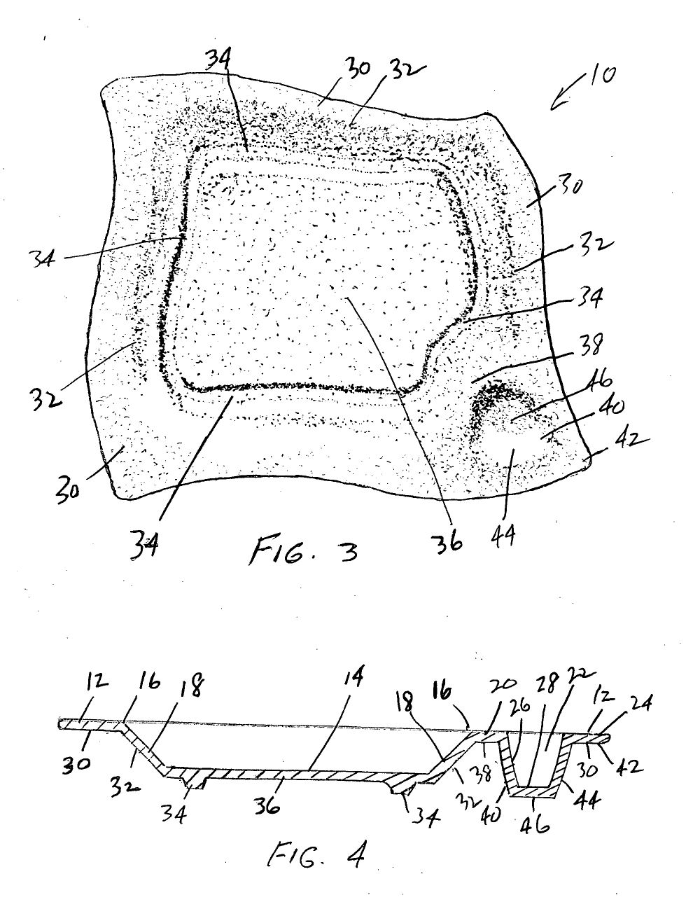

FIG. 3 is a bottom perspective view of the inventive pasta plate 10. The pasta plate 10 has a raised border underside 30 that surrounds perimeter underside 32. The pasta plate 10 is supported by bottom ridge 34, inside of side wall underside 32, and surrounding plate base underside 36. In the preferred embodiment of the present invention shown in FIG. 1, the raised border underside 30 is substantially widened in one area underside 38 to provide a border for a separate high walled recess underside 40 in corner underside 42. The recess preferably has high external walls 44 that approximate the shape of an egg cup, but with a substantially flattened circular bottom underside 46.

FIG. 4 is a cross-sectional view taken along the line 4-4 of FIG. 1. It particularly shows the depth of the high walled recess 22 and its separation at area 20 from the plate base 14. The latter assists in the automatic limitation of the portion of pasta to that of a reasonable mouthful, or alternatively provides a surface to shorten the pasta to accomplish the same purpose. Most, if not all, of the other part numbers described above are also shown and identified by the same part numbers.

While the invention has been described and disclosed in various terms of certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended and their equivalents.

What is claimed is:

1. A pasta plate comprising:
a plate base surrounded by a plate side wall to form a pasta enclosure; and
a high walled recess separated from the pasta enclosure to limit portion size when a fork is twirled therein.

2. The pasta plate of claim 1 wherein the recess further comprises a flat circular bottom to interact with tines of the fork and sized to accommodate the tines' width.

3. The pasta plate of claim 1 in which the recess is substantially in the shape of an egg cup, except for a flat circular bottom to interact with tines of the fork.

4. The pasta plate of claim 1 which further comprises a surface area disposed between the pasta enclosure and the high walled recess to shorten pasta using a utensil such as the fork.

5. A pasta plate comprising:
a plate base surrounded by a plate side wall to form a pasta enclosure; and
a high walled recess substantially in the shape of an egg cup and having a separation from the pasta enclosure to limit portion size when a fork is twirled therein, the recess having a flat circular bottom to interact with tines of the fork and sized to accommodate the tines' width, wherein the separation includes a surface area disposed between the pasta enclosure and the high walled recess to shorten pasta using a utensil such as the fork.
